(19) United States
(12) Patent Application Publication
(10) Pub. No.: US 2006/0010777 A1
(43) Pub. Date: Jan. 19, 2006

(54) Reversible door with dual pivots

(75) Inventors: Chao-Kang Li, Taipei Hsien (TW); Cheng Tu, Taipei Hsien (TW); Pen-Hu Lan, Taipei Hsien (TW); Chia-Chia Huang, Taipei Hsien (TW)

Correspondence Address: BRUCE H. TROXELL, SUITE 1404, 5205 LEESBURG PIKE, FALLS CHURCH, VA, 22041, US

(73) Assignee: AOPEN INC.

(21) Appl. No.: 11/011,126

(22) Filed: Dec. 15, 2004

(30) Foreign Application Priority Data
Jul. 16, 2004 (TW) 093121226

(51) Int. Cl. E05D 7/02

(52) U.S. Cl. 49/382

(57) ABSTRACT

A reversible door with dual pivots includes a frame, a reversible door and two swing arms; the swing arms are attached to the frame and the reversible door at two inner opposite lateral sides of the frame and the reversible door respectively with the two ends of each swing arm having a pivot member pivotally connecting with the pivot members of the frame and the reversible door respectively; the swing arms can be rotated with respect to the frame and the reversible door can be rotated with respect to swing arms; a rotational angle of the reversible door is greater than 180° can be obtained so that the inner lateral sides of the reversible door can be valuably utilized.

### BACKGROUND OF THE INVENTION

1. Field of the Invention

The present invention is related to a reversible door of an electronic product such as a computer, a server or the like and particularly to a pivotal joint structure of a reversible door.

2. Brief Description of Related Art

Taiwanese Patent Official Gazette Publish No. 308,323 discloses a turning door structure of a portable computer and the turning door is pivotally arranged at a socket in the computer for adapting with an extending connector. The socket is provided with a pivotal hole at two opposite lateral walls thereof respectively and the turning door is provided with a pivot at two opposite lateral sides thereof corresponding to the pivotal hole so that the turning door can rotate upward with respect to the pivot. The two lateral walls of the socket have an engaging hole respectively being disposed near the lower edges thereof and the two lateral sides of the turning door are provided with an engaging button respectively corresponding to the engaging hole. The turning door can cover the extending connector before being turned upward.

Further, Taiwanese Patent Official Gazette Publish No. 547,899 discloses a computer casing with a stored up door. The Taiwanese Patent Official Gazette Publish No. 442,720 discloses a rotational inlet-outlet computer door with a hidden type separation hinge.

The turning door disclosed in preceding patents provide a rotational angle less than 120° respectively due to position limitation of pivots at two lateral sides of the turning door pivotally joining the computer casing so that it is not possible for the turning door with a rotational angle greater than 180°. Further, the turning door can only be used for screening and the inner side of the door is unable to be valuably utilized.

Currently, it is a computerized era and computer time used by people is getting longer. The utilization value of the turning door can be enhanced if the turning door can be turned inversely on top of the casing and the inner side of the turning door is associated with a mirror for the women being able to take note of their appearances during operating the computer.

### SUMMARY OF THE INVENTION

An object of the present invention is to provide a reversible door with dual pivots, which can rotate an angle greater than 180°.

Another object of the present invention is to provide a reversible door with dual pivots in which the inner side thereof can be valuably utilized.

A reversible door with dual pivots according to the present invention includes a frame, a reversible door and two swing arms. The frame has a pivot member at two inner opposite lateral sides thereof respectively. The reversible door has a pivot member at two inner opposite lateral sides thereof respectively too corresponding to the pivot member of the frame. The swing arms are attached to the frame and the reversible door at two inner opposite lateral sides of the frame and the reversible door respectively with the two ends of each swing arm having a pivot member pivotally connecting with the pivot members of the frame and the reversible door respectively. The swing arms can be rotated with respect to the frame and the reversible door can be rotated with respect to swing arms. A rotational angle of the reversible door being greater than 180° from the frame can be obtained so that the inner lateral sides of the reversible door can be valuably utilized.

### BRIEF DESCRIPTION OF THE DRAWINGS

The present invention can be more fully understood by reference to the following description and accompanying drawings, in which:

FIG. 1 is a perspective view illustrating a reversible door according to the present invention being pivotally joined to the casing of a main unit;

FIG. 2 is a side view of a reversible door according to the present invention being pivotally joined to a frame of the casing;

FIGS. 3-5 are side views illustrating the reversible door of the present invention being lifted; and

FIG. 6 is a fragmentary perspective view illustrating the reversible door of the present invention providing a pivot associating with a swing arm and a torsion spring.

### DETAILED DESCRIPTION OF THE INVENTION

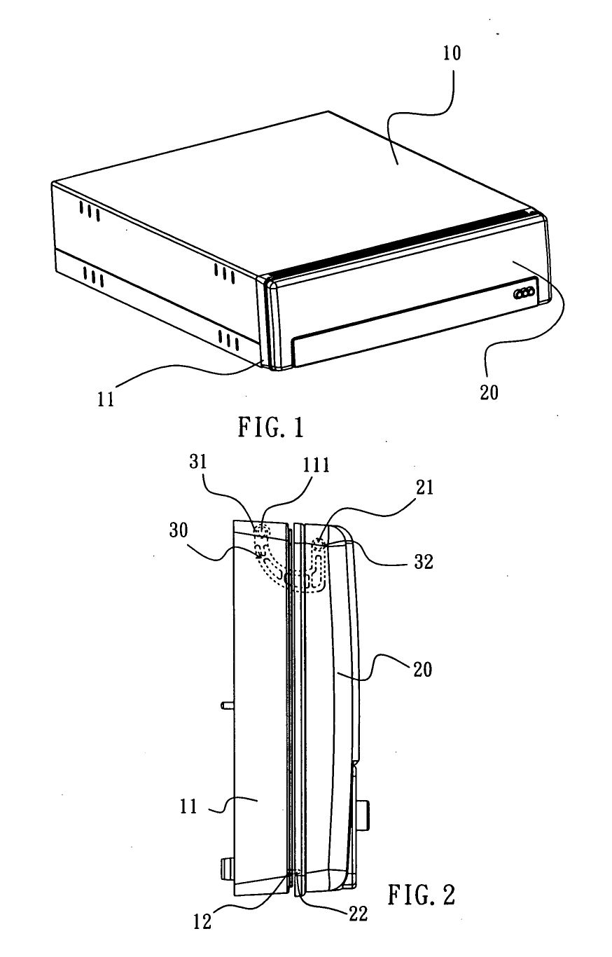

Referring to FIGS. 1-5, a preferred embodiment of the present invention includes a frame 11 at the front side of a casing 10 on an electronic product such as a computer, a server or the like and a reversible door 20. The reversible door 20 is provided with a shape of lid. The frame 11 and the reversible door 20 each are provided with a pivot member pivot member 111, 21 at the inner right and left sides thereof respectively in a way of the pivot members being opposite to each other. The pivot members 111, 21 further pivotally connect with corresponding pivot members 31, 32 at both ends of a swing arm 30. The pivot members 111, 21 and the pivot members 31, 32 can be arranged as pivot holes and pivots and the swing arm 30 has a shape of “L”. The pivot members 31, 32 space apart a distance from each other so that no interference between the reversible door 20 and the frame 11 can occur while the reversible door 20 is opened or closed.

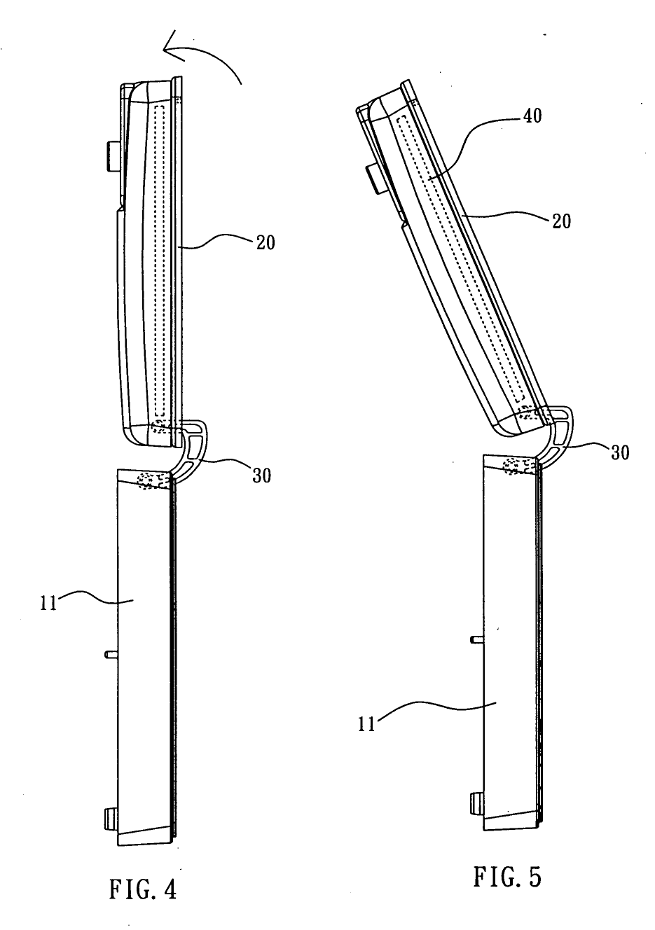

In case of the reversible door 20 being opened, the swing arm 30 is turned with respect to the frame 11 as shown in FIG. 3 and the reversible door 20 can rotate with respect to the swing arm 30 to an angular distance 180° from the frame 11 as shown in FIG. 4. When the reversible door 20 is actuated to rotate an angular displacement further, the reversible door 20 can be displaced on top of the frame 11 and tilt backward an angle as shown in FIG. 5. The reversible door 20 can be associated with articles 40 such as a mirror and pictures at the inner side thereof and the user can see images of the articles 40 from the front side of the frame 11.

The preceding reversible door with dual pivots of the present invention can be rotated an angle greater than 180° with the inner side of thereof being able to be utilized. It is only necessary for the user to take a little care and skill while the reversible door and the two swing arms are operated sequentially and the reversible door and the swing arms can rotate synchronously to enhance smoothness of the reversible door during opening and closing.

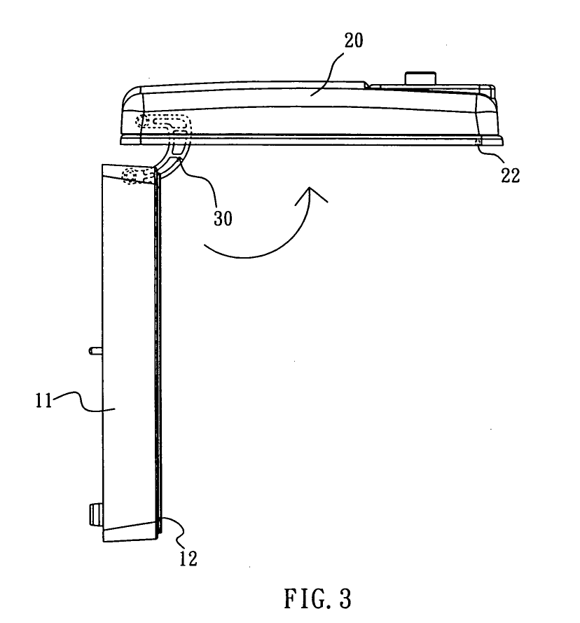

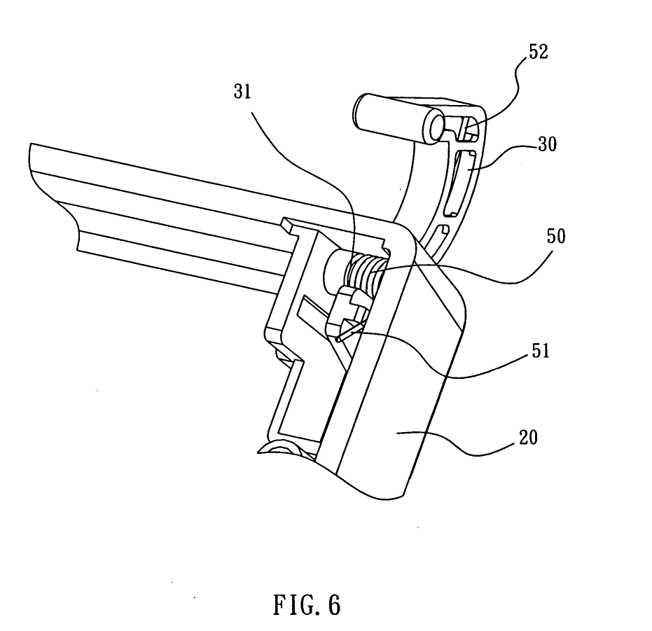

Referring to FIG. 6 in company with FIGS. 1-5, the conjunctions of the two swing arms 30 joined to the frame 11 are attached with a torsion spring 50 respectively. For instance, the middle part of the torsion spring 50 is inserted to the pivot member 31 to surround the pivot of the pivot member 31 at one of the swing arms 30 as shown in FIG. 6 with both ends 51, 52 of the torsion spring 50 being biased against the frame 11 and the swing arm 30 respectively. In case of the reversible door 20 being closed as shown in FIG. 2, the torsion spring 50 is in a state of being subjected to a force at both end 51, 52 thereof. The frame 11 and the reversible door 20 each provide an engaging member 12, 22 such as a magnet piece and an iron piece at the front sides thereof in a way of being opposite to each other so that the frame 11 and the reversible door 20 can engage with each other. When the reversible door 20 is opened as shown in FIG. 3, the both ends 51, 52 of the torsion spring 50 are in a state of being not subjected to a force.

When the reversible door 20 is in state of closing to the frame 11 as shown in FIG. 2, the reversible door 20 can be opened by way of a force exerted by the user to overcome the engaging force of the engaging members 12, 22 such that both ends of the torsion spring 50 create a resilient force to rotate the swing arms 30 at two lateral sides of the reversible door 20 synchronously to the respective dead point of the rotating strokes of the swing arms 30 as shown in FIG. 3. Once the resilient forces at both ends of the torsion spring 50 are sufficient large, the reversible door 20 can rotate with respect to the swing arms 30 over the frame 11 as shown in FIG. 4 and then continues to rotate to a position of full opening as shown in FIG. 5. If the resilient forces at both ends of the torsion spring 50 are not enough to turn the reversible door 20, it is necessary for the user to move the reversible door 20 with hands with respect to the swing arms 30 at two lateral sides of the reversible door 20 and the reversible door 20 can rotate upward and over the frame 11 continuously till the position of full opening over the frame 11.

When the reversible door 20 is to be closed, the reversible door 20 is rotated with respect to the swing arms 30 first due to resistance of the torsion spring 50 at the conjunctions of the swing arms 30 and the frame 11 in order to avoid interference between the reversible door 20 and the frame 11. Then, the swing arms 30 at two lateral sides of the reversible door 20 are rotated synchronously such that both ends of the torsion spring 50 are subjected to a force and the engaging members 12, 22 can be in a state of engaging with each other as shown in FIG. 2.

An ordinary hinge controls the resistant force of the rotational shaft by way of friction coefficient, friction area and magnitude of the force to meet requirement of different rotational shafts rotating sequentially. However, the hinge is complicated and expensive while it is fabricated. The present invention only provides a rotational shaft associated with a torsion spring to meet requirement of different rotational shafts being controlled to rotate sequentially so that a great deal of production cost can be saved effectively.

While the invention has been described with referencing to a preferred embodiment thereof, it is to be understood that modifications or variations may be easily made without departing from the spirit of this invention, which is defined by the appended claims.

What is claimed is:

1. A reversible door with dual pivots, comprising:
a frame, providing a first pivot member at two inner opposite lateral sides thereof respectively;
a reversible door, providing a second pivot member at two inner opposite lateral sides thereof respectively corresponding to the first pivot member; and
a swing arm with two ends, being attached to the frame and the reversible door at the inner opposite lateral sides thereof with the two ends providing a third pivot member pivotally connecting with the first pivot member and the second pivot member respectively;
whereby, the swing arm can be rotate with respect to the frame and the reversible door can be rotated with respect to the swing arm with a rotational angle greater than 180°.

2. The reversible door with dual pivots as defined in claim 1, wherein the swing arm has a shape of “L”.

3. The reversible door with dual pivots as defined in claim 1, wherein the pivot members are pivot holes and pivots corresponding to each other.

4. The reversible door with dual pivots as defined in claim 1, wherein a conjunction of the frame and the swing arm is associated with a torsion spring respectively with both ends of the torsion spring being biased against the frame and the swing arm and both the ends being subjected to a force while the reversible door is closed.

5. The reversible door with dual pivots as defined in claim 1, wherein the third pivot member at both ends of the swing arm spaces apart a distance and no interference occurs between the swing arm and the frame while the reversible door is opened or closed.

6. The reversible door with dual pivots as defined in claim 1, wherein the frame is disposed at the front side of a casing on an electronic product.

7. The reversible door with dual pivots as defined in claim 4, wherein a middle part of the torsion spring fits with the third pivot member and the third pivot member is a pivot.

8. The reversible door with dual pivots as defined in claim 4, wherein the frame and the reversible door at the front sides thereof have an engaging member corresponding to each other.

9. The reversible door with dual pivots as defined in claim 6, wherein the electronic product is a computer.

10. The reversible door with dual pivots as defined in claim 8, wherein the engaging members are a magnet piece and an iron pieces.
